(19) United States
(12) Patent Application Publication
(10) Pub. No.: US 2005/0270411 A1
(43) Pub. Date: Dec. 8, 2005

(54) Imaging device and portable terminal device

(75) Inventors: Masaru Kawabata, Tokyo (JP); Kazuhiro Tanaka, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/138,470

(22) Filed: May 27, 2005

(30) Foreign Application Priority Data
Jun. 7, 2004 (JP) P2004-168924

(51) Int. Cl. H04N 5/235

(52) U.S. Cl. 348/362

(57) ABSTRACT

The present invention provides an imaging device including an electric light control device disposed between lens groups, a CCD photosensitive surface and including a liquid crystal cell which contains at least a dye pigment for providing a predetermined light control range, a CPU for supplying an applied voltage to place the electric light control device in the predetermined light control range based on amount-of-light information obtained from the CCD, and a numerical parameter value table for storing a numerical parameter value relative to a threshold value for a transmittance of the electric light control device in order to generate the applied voltage to be supplied from the CPU to the electric light control means.

### BACKGROUND OF THE INVENTION

The present invention relates to an imaging device and a portable terminal device which are capable of controlling the amount of incident light.

In recent years, there has been a growing demand for higher-resolution, smaller imaging devices such as video cameras and digital still cameras. To meet such a demand, video cameras and digital still cameras have been designed to incorporate higher-density CCDs (Charge-Coupled Devices) and smaller lenses. However, these solutions suffer a significant image quality degradation due to diffraction. In addition, because movable components of the mechanical irises of lens units incorporated in imaging devices have a limited size, a limitation is posed on efforts to make the imaging devices smaller in size.

There has been proposed a light control device comprising a dichroic GH (Guest Host) liquid crystal device which provides a light transmittance that is flat with respect to only a certain wavelength corresponding to a pigment mixed with liquid crystal molecules. The liquid crystal device operates based on its property that the pigment accompanies the liquid crystal molecules when the liquid crystal device is energized. For details, see Japanese Patent Laid-Open No. 2001-201769, for example. The dichroic GH liquid crystal device has large temperature-dependent characteristics due to its material properties.

The dichroic GH liquid crystal device has its response speed lower as the temperature in which it is used is lower because the viscosity of the liquid crystal is higher as the temperature thereof is lower.

The present applicant has proposed an electric light control device for improving the response speed of the dichroic GH liquid crystal device as disclosed in Japanese Patent Laid-Open No. 2003-43553.

However, since the proposed electric light control device starts operating after an applied voltage increases beyond a threshold value of an area wherein the dichroic GH liquid crystal device is not activated, the electric light control device is not suitable for use in a portable device that is required to be used in a wide temperature range.

### SUMMARY OF THE INVENTION

It is an object of the present invention to provide an imaging device and a portable terminal device which have an increased response speed for use in portable devices by being activated by an applied voltage that takes into account a threshold value of a dichroic GH liquid crystal device which is used to control the amount of incident light.

To achieve the above object, there are provided in accordance with the present invention an imaging device and a portable terminal device for imaging a subject, comprising an optical system, imaging means for imaging the subject through the optical system, light control means disposed between the optical system and the imaging means and including an electric light control device comprising a liquid crystal cell containing at least a dye pigment for providing a predetermined light control range, control means for supplying an applied voltage to place the light control means in the predetermined light control range based on amount-of-light information obtained from the imaging means, and storage means for storing a numerical parameter value relative to a threshold value for a transmittance of the light control means in order to generate the applied voltage to be supplied from the control means to the light control means.

With this configuration, the light control means is disposed between the optical system and the imaging means, and includes an electric light control device comprising the liquid crystal cell containing at least a dye pigment for providing a predetermined light control range. The control means supplies an applied voltage to place the light control means in the predetermined light control range based on amount-of-light information obtained from the imaging means. The storage means stores a numerical parameter value relative to a threshold value for a transmittance of the light control means in order to generate the applied voltage to be supplied from the control means to the light control means.

Therefore, the control means can generate the applied voltage to be supplied to the light control means based on the numerical parameter value, which is stored in the storage means, relative to the threshold value for the transmittance of the light control means.

The control means can thus supply the light control means with an applied voltage equal to or higher than the threshold value for the transmittance of the light control means. Consequently, the response speed of the light control means can be improved.

According to the present invention, the imaging device and the portable terminal device can have an increased response speed by being activated by an applied voltage that takes into account a threshold value of a dichroic GH liquid crystal device which is used to control the amount of incident light, and can be used in a portable device.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a view, partly in block form, an imaging device including an optical system, which incorporates an electric light control device, according to the present invention;

FIG. 2A is a cross-sectional view, partly in block form, of the electric light control device;

FIG. 2B is a perspective view of the electric light control device;

FIG. 3A is a diagram showing applied-voltage vs. transmittance (light intensity) characteristics in a voltage drive mode of a dichroic GH liquid crystal device;

FIG. 3B is a diagram showing duty-ratio vs. transmittance (light intensity) characteristics in a PWM drive mode of the dichroic GH liquid crystal device;

FIG. 4 is a diagram showing response speeds at a maximum transmittance and a drive transmittance;

FIG. 5A is a diagram showing the frequency dependency of applied-voltage vs. transmittance characteristics in the voltage drive mode of the electric light control device; and

FIG. 5B is a diagram showing the frequency dependency of duty-ratio vs. transmittance characteristics in the PWM drive mode of the electric light control device.

### DETAILED DESCRIPTION OF THE PREFERRED EMBODIMENT

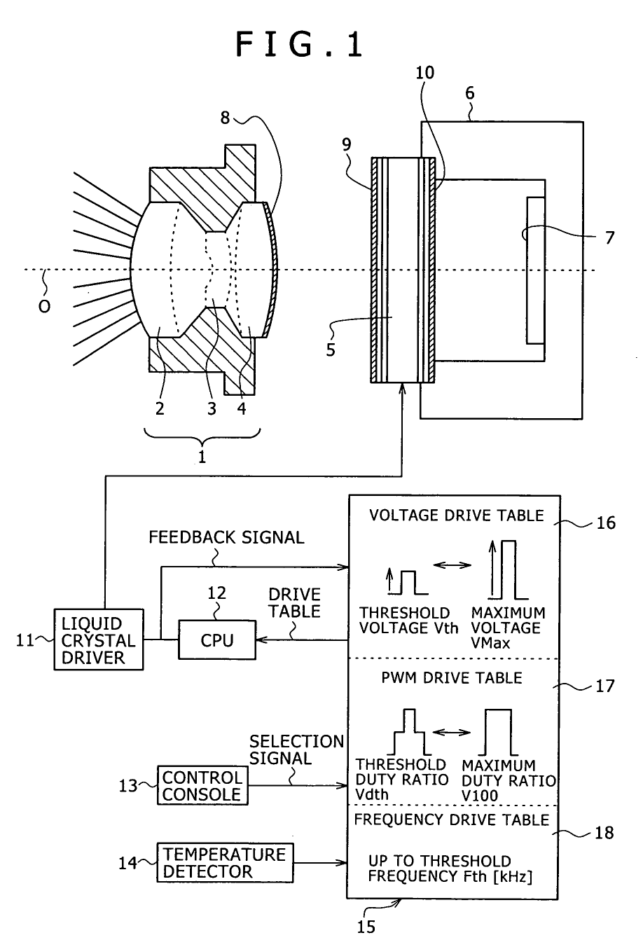

FIG. 1 shows, partly in block form, a portable terminal imaging device including an optical system, which incorporates an electric light control device, according to the present invention. In FIG. 1, an electric light control device 5, which serves as an electric light control unit for use in an imaging device according to the present invention, is incorporated as part of a CCD imaging device in a portable terminal device such as a cellular phone set or the like.

As shown in FIG. 1, the optical system of the portable terminal device includes a lens assembly 1 having a lens group 2 and a lens group (zoom lens group) 3 that serve as front lens groups, a lens group and a lens group (focus lens group) 4 that serve as rear lens groups, and a solid-state imaging unit 6 comprising a CCD having a photosensitive surface 7. The solid-state imaging unit 6 is spaced a predetermined distance from the lens assembly 1 along an optical axis O indicated by a dashed line. An IR (InfraRed) cut coat 8 is placed, instead of a cover glass panel, on the surface of the focus lens group 4 which faces the solid-state imaging unit 6.

An electric light control device 5 comprising a dichroic GH liquid crystal device is disposed between lens group 4 and the photosensitive surface 7 of the solid-state imaging unit 6. IR cut coats 9, 10 are placed, instead of polarizers for adjusting an amount of light, i.e., for restricting an amount of light, on respective front and rear surfaces of the electric light control device 5 that are spaced apart from each other along the optical axis O. The focus lens group 4 is movable along the optical axis between the zoom lens group 3 and the solid-state imaging unit 6 by an actuator (not shown). The zoom lens group 3 is movable along the optical axis O between the lens group 2 and the focus lens group 4 by an actuator (not shown).

A CPU (Central Processing Unit) 12 reads applied voltage data from a drive table selected from a numerical parameter value table 15 as a storage unit based on a selection signal from a control console 13, and supplies the applied voltage data to a liquid crystal driver 11. The liquid crystal driver 11 generates an applied voltage based on the applied voltage data, and supplied the generated applied voltage to the electric light control device 5.

The numerical parameter value table 15 has a voltage drive table 16 of voltages for applying a voltage equal to or higher than a threshold value from an initial value and then applying a voltage of a desired value, a PWM (Pulse Width Modulation) drive table 17 of duty ratios for applying a voltage at a duty ratio equal to or higher than a threshold value from an initial value and then applying a voltage at a duty ratio of a desired value, and a frequency drive table 18 for energizing the electric light control device 5 at a frequency equal to or lower than a threshold value.

The control console 13 outputs a selection signal for reading either one of the voltage drive table 16, the PWM drive table 17, and the frequency drive table 18 from the numerical parameter value table 15.

A temperature detector 14 detects the temperature in which the imaging device is used. The threshold values in the numerical parameter value table 15 can be changed depending on the temperature detected by the temperature detector 14.

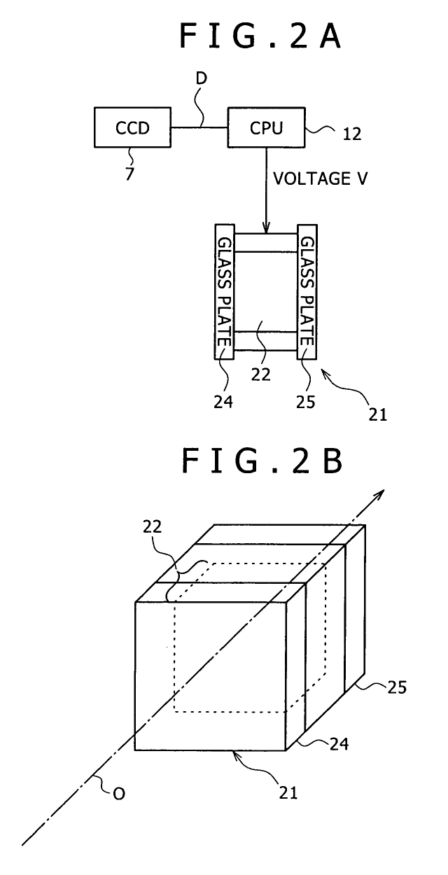

FIG. 2A shows in cross section, partly in block form, the electric light control device 5, and FIG. 2B shows in perspective the electric light control device 5. In FIGS. 2A and 2B, the electric light control device 5 is illustrated as an electric light control device 21 comprising a dichroic GH liquid crystal device. As shown in FIG. 2A, the electric light control device 21 has a liquid crystal cell 22 sandwiched between glass plates 24, 25 having a high light transmittance that are disposed respectively on the front and rear surfaces of the liquid crystal cell 22. The liquid crystal cell 22 has its peripheral surfaces shielded by other members. The CPU 12 controls an applied voltage V supplied to the electric light control device 21 based on amount-of-light data D from the CCD 7.

As shown in FIG. 2B, the liquid crystal cell 22 of the electric light control device 21 is disposed along the optical axis O. Though the liquid crystal cell 22 is illustrated as having a significant thickness in FIGS. 2A and 2B, it is actually constructed as a thin film.

The liquid crystal cell 22 is supplied with the applied voltage V from the CPU 12 for driving itself. The applied voltage V is generated by the CPU 12 for driving the liquid crystal cell 22 in a predetermined light control range. The liquid crystal cell 22 contains at least a dye pigment.

Transmittance (light intensity) characteristics of the dichroic GH liquid crystal device with respect to applied voltages will be described below.

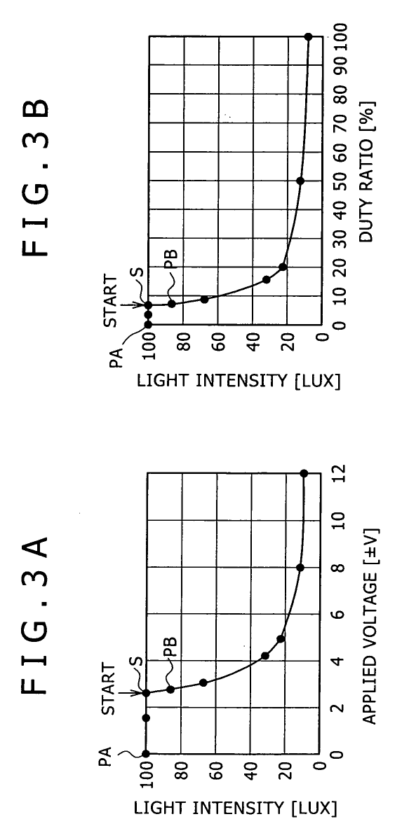

FIG. 3A shows applied-voltage vs. transmittance (light intensity) characteristics in a voltage drive mode of the dichroic GH liquid crystal device, and FIG. 3B shows duty-ratio vs. transmittance (light intensity) characteristics in a PWM drive mode of the dichroic GH liquid crystal device. In FIG. 3A, voltages are applied as pulsed voltages in the voltage drive mode. In FIG. 3B, voltages are applied at duty ratios in the PWM drive mode.

In FIG. 3A, since the pigment contained in the liquid crystal cell 22 is a dye material, when the applied voltage ranges from 0 V to about 3 V, the light intensity remains substantially unchanged to be 100 luxes, from an initial value PA to a threshold value S. When the applied voltage ranges from about 3 V to 8 V, the light intensity changes in a variable range from 100 luxes to 10 luxes from the threshold value S to a target value subsequent to PB. The variable range from 100 luxes to 10 luxes is a drive range for the electric light control device 21, which is provided by the applied voltages in excess of the threshold value.

In FIG. 3B, since the pigment contained in the liquid crystal cell 22 is a dye material, when the duty ratio of the applied voltage ranges from 0% to 8%, the light intensity remains substantially unchanged to be 100 luxes from an initial value PA to a threshold value S. When the duty ratio of the applied voltage ranges from 8% to 50%, the light intensity changes in a variable range from 100 luxes to 10 luxes from the threshold value S to a target value subsequent to PB. The variable range from 100 luxes to 10 luxes is a drive range for the electric light control device 21, which is provided by the duty ratio of the applied voltages in excess of the threshold value.

As described above, the electric light control device 21 is not activated immediately when a voltage is applied thereto, but is activated when a voltage having a level equal to or higher than a threshold value or a voltage having a duty ratio equal to or higher than a threshold value is applied thereto. Insofar as the electric light control device 21 is not activated, the transmittance remains unchanged. Since the electric light control device 21 is put in the drive range by an applied voltage in excess of the threshold value, the electric light control device 21 has an increased response speed. The threshold value for the applied voltage varies in a variable temperature range. Therefore, the threshold value is changed depending on the temperature in which the imaging device is used.

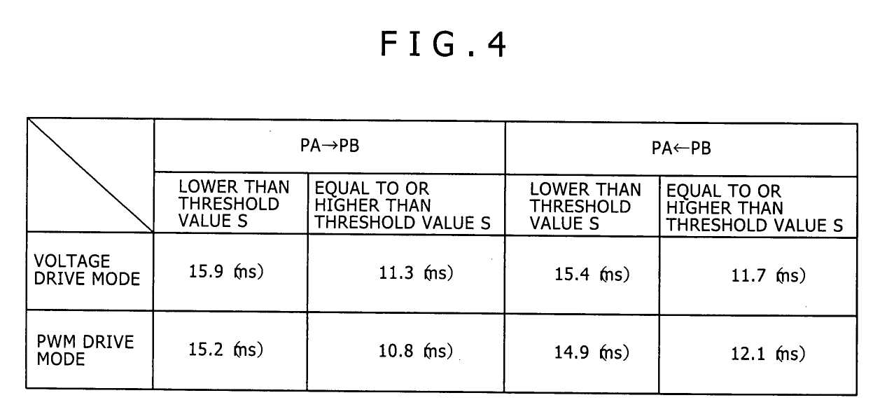

FIG. 4 shows response speeds at a maximum transmittance and a drive transmittance.

In FIG. 4, when the liquid crystal cell 22 is activated in the voltage drive mode by a voltage lower than the threshold value S in the transmittance (light intensity) characteristics shown in FIG. 3A to achieve a light intensity ranging from the light intensity corresponding to PA to the light intensity corresponding to PB, the response speed of the light crystal cell 22 is 15.5 ms. When the liquid crystal cell 22 is activated in the voltage drive mode by a voltage equal to or higher than the threshold value S in the transmittance (light intensity) characteristics shown in FIG. 3A to achieve a light intensity ranging from the light intensity corresponding to PA to the light intensity corresponding to PB, the response speed of the light crystal cell 22 is 11.3 ms.

When the liquid crystal cell 22 is activated in the PWM drive mode by a voltage lower than the threshold value S in the transmittance (light intensity) characteristics shown in FIG. 3B to achieve a light intensity ranging from the light intensity corresponding to PA to the light intensity corresponding to PB, the response speed of the light crystal cell 22 is 15.2 ms. When the liquid crystal cell 22 is activated in the PWM drive mode by a voltage equal to or higher than the threshold value S in the transmittance (light intensity) characteristics shown in FIG. 3B to achieve a light intensity ranging from the light intensity corresponding to PA to the light intensity corresponding to PB, the response speed of the light crystal cell 22 is 10.8 ms.

Conversely, when the liquid crystal cell 22 is activated in the voltage drive mode by a voltage lower than the threshold value S in the transmittance (light intensity) characteristics shown in FIG. 3A to achieve a light intensity ranging from the light intensity corresponding to PB to the light intensity corresponding to PA, the response speed of the light crystal cell 22 is 15.4 ms. When the liquid crystal cell 22 is activated in the voltage drive mode by a voltage equal to or higher than the threshold value S in the transmittance (light intensity) characteristics shown in FIG. 3A to achieve a light intensity ranging from the light intensity corresponding to PB to the light intensity corresponding to PA, the response speed of the light crystal cell 22 is 11.7 ms.

When the liquid crystal cell 22 is activated in the PWM drive mode by a voltage lower than the threshold value S in the transmittance (light intensity) characteristics shown in FIG. 3B to achieve a light intensity ranging from the light intensity corresponding to PB to the light intensity corresponding to PA, the response speed of the light crystal cell 22 is 14.9 ms. When the liquid crystal cell 22 is activated in the PWM drive mode by a voltage equal to or higher than the threshold value S in the transmittance (light intensity) characteristics shown in FIG. 3B to achieve a light intensity ranging from the light intensity corresponding to PB to the light intensity corresponding to PA, the response speed of the light crystal cell 22 is 12.1 ms.

It can be confirmed that the response speed of the light crystal cell 22 increases when the light crystal cell 22 is activated by a voltage in an range beyond the threshold value S. Since the light intensity, i.e., the transmittance, of the liquid crystal cell 22 remains the same when the applied voltage is lower than the threshold value, the response speed of the liquid crystal cell 22 can be increased when the liquid crystal cell 22 is activated by a voltage in excess of the threshold value or a voltage having a duty ratio in excess of the threshold value.

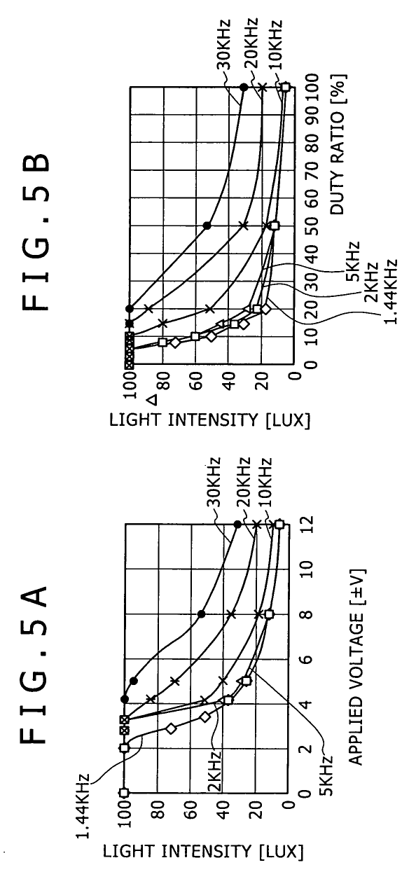

FIG. 5A shows the frequency dependency of applied-voltage vs. transmittance characteristics in the voltage drive mode of the electric light control device 21, and FIG. 5B shows the frequency dependency of duty-ratio vs. transmittance characteristics in the PWM drive mode of the electric light control device 21.

If the liquid crystal cell 22 is activated at a relatively low drive frequency of 1.44 kHz in the applied-voltage vs. transmittance characteristics shown in FIG. 5A, then when the applied voltage ranges from 0 V to 2 V, the light intensity remains substantially unchanged in a constant range of 100 luxes from the initial value to the threshold value. When the applied voltage ranges from 2 V to 8 V, the light intensity changes in a variable range from 100 luxes to 10 luxes from the threshold value to the target value.

If the liquid crystal cell 22 is activated at a relatively low drive frequency of 2 kHz, then when the applied voltage ranges from 0 V to 3 V, the light intensity remains substantially unchanged in a constant range of 100 luxes from the initial value to the threshold value. When the applied voltage ranges from 3 V to 8 V, the light intensity changes in a variable range from 100 luxes to 10 luxes from the threshold value to the target value.

If the liquid crystal cell 22 is activated at a relatively low drive frequency of 5 kHz, then when the applied voltage ranges from 0 V to 3 V, the light intensity remains substantially unchanged in a constant range of 100 luxes from the initial value to the threshold value. When the applied voltage ranges from 3 V to 8 V, the light intensity changes in a variable range from 100 luxes to 10 luxes from the threshold value to the target value.

If the liquid crystal cell 22 is activated at a relatively medium drive frequency of 10 kHz, then when the applied voltage ranges from 0 V to 3 V, the light intensity remains substantially unchanged in a constant range of 100 luxes from the initial value to the threshold value. When the applied voltage ranges from 3 V to 8 V, the light intensity changes in a variable range from 100 luxes to 20 luxes from the threshold value to the target value.

If the liquid crystal cell 22 is activated at a relatively somewhat high drive frequency of 20 kHz, then when the applied voltage ranges from 0 V to 3 V, the light intensity remains substantially unchanged in a constant range of 100 luxes from the initial value to the threshold value. When the applied voltage ranges from 3 V to 8 V, the light intensity changes in a smoothly variable range from 100 luxes to 35 luxes from the threshold value to the target value.

If the liquid crystal cell 22 is activated at a relatively high drive frequency of 30 kHz, then when the applied voltage ranges from 0 V to 4 V, the light intensity remains substantially unchanged in a constant range of 100 luxes from the initial value to the threshold value. When the applied voltage ranges from 4 V to 8 V, the light intensity changes in a more smoothly variable range from 100 luxes to 55 luxes from the threshold value to the target value.

If the liquid crystal cell 22 is activated at a relatively low drive frequency of 1.44 kHz in the duty-ratio vs. transmittance characteristics shown in FIG. 5B, then when the duty ratio of the applied voltage ranges from 0% to 5%, the light intensity remains substantially unchanged in a constant range of 100 luxes from the initial value to the threshold value. When the duty ratio of the applied voltage ranges from 5% to 50%, the light intensity changes in a variable range from 100 luxes to 10 luxes from the threshold value to the target value.

If the liquid crystal cell 22 is activated at a relatively low drive frequency of 2 kHz, then when the duty ratio of the applied voltage ranges from 0% to 5%, the light intensity remains substantially unchanged in a constant range of 100 luxes from the initial value to the threshold value. When the duty ratio of the applied voltage ranges from 5% to 50%, the light intensity changes in a variable range from 100 luxes to 10 luxes from the threshold value to the target value.

If the liquid crystal cell 22 is activated at a relatively low drive frequency of 5 kHz, then when the duty ratio of the applied voltage ranges from 0% to 5%, the light intensity remains substantially unchanged in a constant range of 100 luxes from the initial value to the threshold value. When the duty ratio of the applied voltage ranges from 5% to 50%, the light intensity changes in a variable range from 100 luxes to 10 luxes from the threshold value to the target value.

If the liquid crystal cell 22 is activated at a relatively medium drive frequency of 10 kHz, then when the duty ratio of the applied voltage ranges from 0% to 10%, the light intensity remains substantially unchanged in a constant range of 100 luxes from the initial value to the threshold value. When the duty ratio of the applied voltage ranges from 10% to 50%, the light intensity changes in a variable range from 100 luxes to 20 luxes from the threshold value to the target value.

If the liquid crystal cell 22 is activated at a relatively somewhat high drive frequency of 20 kHz, then when the duty ratio of the applied voltage ranges from 0% to 15%, the light intensity remains substantially unchanged in a constant range of 100 luxes from the initial value to the threshold value. When the duty ratio of the applied voltage ranges from 15% to 50%, the light intensity changes in a smoothly variable range from 100 luxes to 30 luxes from the threshold value to the target value.

If the liquid crystal cell 22 is activated at a relatively high drive frequency of 30 kHz, then when the duty ratio of the applied voltage ranges from 0% to 20%, the light intensity remains substantially unchanged in a constant range of 100 luxes from the initial value to the threshold value. When the duty ratio of the applied voltage ranges from 20% to 50%, the light intensity changes in a more smoothly variable range from 100 luxes to 55 luxes from the threshold value to the target value.

It can be confirmed that the change in the light intensity, i.e., the change in the transmittance, is gradually reduced when the drive frequency at which to activate the liquid crystal cell 22 is shifted from a relatively low range to a relatively high range. At this time, the threshold values for the applied voltage and the duty ratio are also gradually reduced when the drive frequency at which to activate the liquid crystal cell 22 is shifted from a relatively low range to a relatively high range.

Unless the liquid crystal cell 22 is activated at equal to or less than a drive frequency depending on the electric light control device 21, the light controlling capability of the electric light control device 21 will be lost before the response speed thereof increases.

For using the electric light control device 21, a threshold value is established in advance for the drive frequency of the electric light control device 21, and the electric light control device 21 is activated at a drive frequency lower than the threshold value. The threshold value for the drive frequency of the electric light control device 21 is established by setting the CPU 12 to a parameter corresponding to the electric light control device 21 to be used in the frequency drive table 18 in the numerical parameter value table 15 depending on the electric light control device 21 to be used as indicated by the control console 13 shown in FIG. 1.

At this time, a parameter in the frequency drive table 18 in the numerical parameter value table 15 may be selected based on temperature information from the temperature detector 14.

In the above illustrated embodiment, the numerical parameter value table 15 contains the drive tables that store numerical parameter values relative to threshold values for achieving transmittances in order to generate applied voltages to be supplied to the electric light control device 21. However, the CPU 12 may directly calculate parameters in the drive tables.

Although a certain preferred embodiment of the present invention has been shown and described in detail, it should be understood that various changes and modifications may be made therein without departing from the scope of the appended claims.

1. An imaging device for imaging a subject, comprising:
an optical system;
imaging means for imaging the subject through said optical system;
light control means disposed between said optical system and said imaging means and including an electric light control device comprising a liquid crystal cell containing at least a dye pigment for providing a predetermined light control range;
control means for supplying an applied voltage to place said light control means in said predetermined light control range based on amount-of-light information obtained from said imaging means; and
storage means for storing a numerical parameter value relative to a threshold value for a transmittance of said light control means in order to generate the applied voltage to be supplied from said control means to said light control means.

2. An imaging device according to claim 1, wherein said electric light control device comprises a dichroic GH liquid crystal device.

3. An imaging device according to claim 1, wherein said storage means comprises a voltage drive table of voltages for applying a voltage equal to or higher than a threshold value from an initial value and then applying a voltage of a desired value.

4. An imaging device according to claim 1, wherein said storage means comprises a PWM drive table of duty ratios for applying a voltage at a duty ratio equal to or higher than a threshold value from an initial value and then applying a voltage at a duty ratio of a desired value.

5. An imaging device according to claim 1, wherein said storage means comprises a frequency drive table for energizing said light control means at a frequency equal to or lower than a threshold value.

6. A portable terminal device for imaging a subject, comprising:
an optical system;
imaging means for imaging the subject through said optical system;
light control means disposed between said optical system and said imaging means and including an electric light control device comprising a liquid crystal cell containing at least a dye pigment for providing a predetermined light control range;
control means for supplying an applied voltage to place said light control means in said predetermined light control range based on amount-of-light information obtained from said imaging means; and
storage means for storing a numerical parameter value relative to a threshold value for a transmittance of said light control means in order to generate the applied voltage to be supplied from said control means to said light control means.

7. A portable terminal device according to claim 6, wherein said electric light control device comprises a dichroic GH liquid crystal device.

8. A portable terminal device according to claim 6, wherein said storage means comprises a voltage drive table of voltages for applying a voltage equal to or higher than a threshold value from an initial value and then applying a voltage of a desired value.

9. A portable terminal device according to claim 6, wherein said storage means comprises a PWM drive table of duty ratios for applying a voltage at a duty ratio equal to or higher than a threshold value from an initial value and then applying a voltage at a duty ratio of a desired value.

10. A portable terminal device according to claim 6, wherein said storage means comprises a frequency drive table for energizing said light control means at a frequency equal to or lower than a threshold value.
